(19) United States
(12) Patent Application Publication
(10) Pub. No.: US 2013/0135974 A1
(43) Pub. Date: May 30, 2013

(54) BALANCE SPRING AND METHOD FOR MANUFACTURING SAME

(71) Applicants: Philippe NIEDERMANN, Peseux (CH); Jacek BABOROWSKI, Auvernier (CH)

(72) Inventors: Philippe NIEDERMANN, Peseux (CH); Jacek BABOROWSKI, Auvernier (CH)

(73) Assignee: CSEM CENTRE SUISSE D'ELECTRONIQUE ET DE MICROTECHNIQUE SA RECHERCHE ET DEVEL, Neuchatel (CH)

(21) Appl. No.: 13/325,410

(22) Filed: Dec. 14, 2011

(30) Foreign Application Priority Data
Nov. 25, 2011 (EP) 11190694.7

(51) Int. Cl. G04B 17/06; C23F 1/00

(52) U.S. Cl. 368/175; 216/53

(57) ABSTRACT

The present invention relates to a balance spring intended to equip a balance of a mechanical timepiece, formed by a spiral bar resulting from machining a fused quartz plate, which has a positive thermal coefficient of rigidity, the bar constituting a core at least locally covered by at least one outer layer having a different structure to modify the thermal coefficient of rigidity.

### TECHNICAL FIELD

The present invention relates to the general technical field of the regulator organ of timepieces, called the sprung balance. It more particularly relates, on the one hand, to a balance spring intended to equip the balance of a mechanical timepiece and, on the other hand, to a method for manufacturing such a balance spring.

The regulator organ of mechanical watches is made up of an inertia wheel, called balance, and a spiral spring, called hairspring or balance spring, that is fixed by one end on the axis of the balance and by the other end on a bridge, called a cock, in which the axis of the balance pivots.

The sprung balance oscillates around its equilibrium position (or dead point). When the balance leaves that position, it winds the spring. This creates a return torque that, when the balance is released, causes it to return to its equilibrium position. Since it has acquired a certain speed, therefore a kinetic energy, it exceeds its dead point until the contrary torque of the spring stops it and forces it to turn in the other direction. In this way, the spring regulates the oscillation period of the balance.

The balance spring equipping mechanical watch movements is for example an elastic metal blade with a rectangular section wound on itself in a spiral of Archimedes and including 12 to 15 turns. It will be recalled that the spring is primarily characterized by its return torque M, expressed on first approximation by the formula:

M=E/L(w³·t/12·φ)

with:

E: Young's modulus of the blade [N/m2],

t: thickness of the spring,

w: width of the spring,

L: length of the spring,

φ angle of torsion (rotation of the pivot).

One will therefore easily understand that the return or rigidity constant of a spring

C=M/φ,

which characterizes the return torque by angle of torsion unit, must be as stable as possible, irrespective in particular of the temperature and the magnetic field. The material used is therefore of crucial importance.

However, it is known that the Young's modulus of an elastic blade varies with the temperature, which influences the behavior of the spring and the regularity of the operation of the regulator organ it equips. Freeing the operation of the regulator organ from the influence of the temperature is a long-standing challenge for horologists.

### BACKGROUND OF THE INVENTION

One has for example sought to produce springs whereof the Young's modulus depends as little as possible on the temperature. Thus known via document CH 307 683 are glasses whereof the silica content is between 75% and 85% used to form an elastic element for chronometric apparatuses. These glasses have the particularity of having a practically zero thermo-elastic coefficient. They are, however, difficult to shape precisely and to handle.

Also known, from document EP 1 791 039, is a balance spring having a thermal coefficient of the Young's modulus close to zero. This document also describes its manufacture method. The material making up the spring is photo-structurable glass (e.g. Foturan). The modification of the glass, on at least certain areas of the turns, is obtained via UV radiation to modify its thermal coefficient of the Young's modulus, via a specific chemical reaction of metal elements contained in the glass. The UV radiation is also used in association with a high-temperature thermal treatment to then eliminate, using chemical etching, the material zones located between the turns of the balance spring. Such a manufacturing method is long and complex to carry out. Implementing such a method requires complex and expensive manufacturing and verification means, in particular to perform a localized treatment at a high temperature. The selectivity between the radiated and non-radiated zone is around 10.

### BRIEF DESCRIPTION OF THE INVENTION

The invention aims to resolve the aforementioned drawbacks by providing a balance spring that is easy, precise and reproducible to manufacture.

The invention also aims to provide a thermo-compensated balance spring, to compensate the thermal drift of its resonance frequency (TCF) effectively and lastingly.

The aims of the invention are achieved using a balance spring and its manufacturing method as defined in the claims.

In this document, the material called “fused quartz” or “fused silica” is defined broadly to designate a material produced from synthetic quartz or synthetic silica.

### BRIEF DESCRIPTION OF THE DRAWINGS

Other features of the present invention will appear more clearly upon reading the following description, done in reference to the appended drawing, provided as a non-limiting example, in which:

FIG. 1 illustrates a transverse section of an example of a spiral bar forming a balance spring according to the invention,

FIG. 2a shows an example of an embodiment of a balance spring according to the invention,

FIG. 2b shows an example of an embodiment of a balance spring-balance assembly according to the invention,

FIGS. 3, 4 and 5 illustrate various alternative embodiments of a thermomechanical compensation of the bar of FIG. 1, and

FIG. 6 illustrates a transverse section of an example of a spiral bar obtained according to the invention.

### DETAILED DESCRIPTION OF THE INVENTION

The structurally and functionally identical elements present in several different figures are given a same numeric or alphanumeric reference.

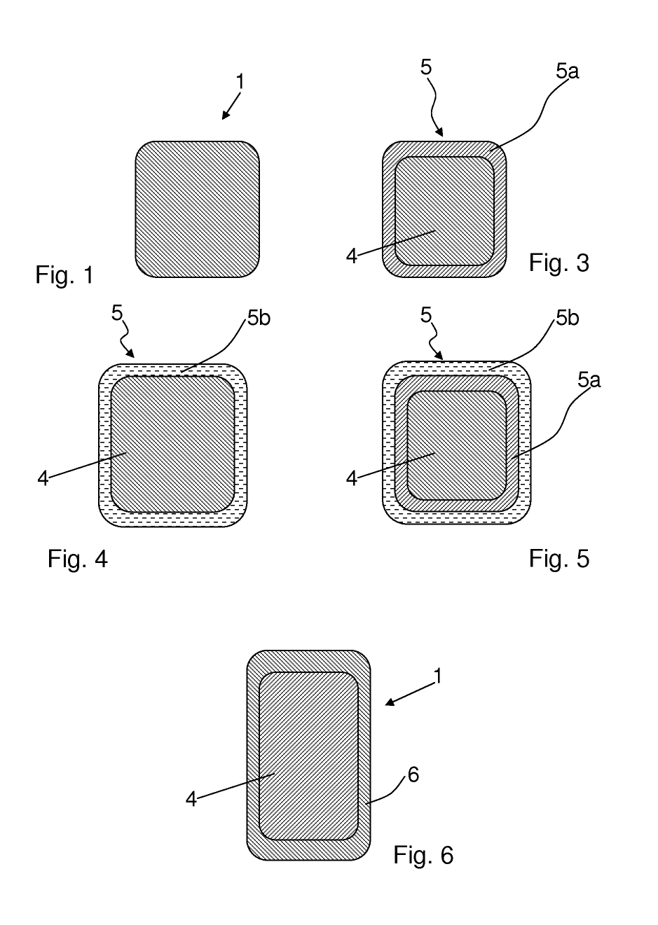

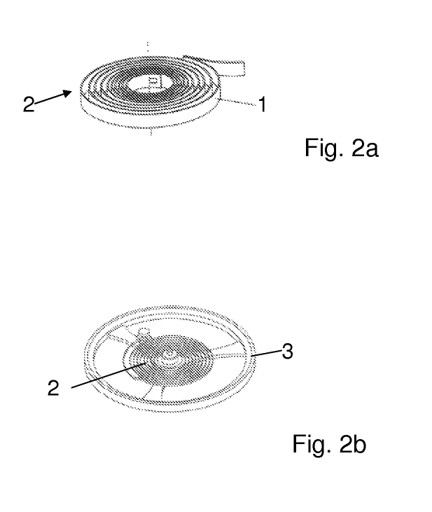

FIG. 1 illustrates a transverse section of an example of a spiral bar 1, intended to form a balance spring 2 according to the invention, illustrated for example in FIG. 2a.

According to the invention, the bar 1 is made with a base of fused quartz. Fused quartz is an amorphous and isotropic material having a positive thermal coefficient of rigidity TCE of about 200 ppm/° K and a thermal coefficient of expansion of about 0.38 ppm/° K. It is made up exclusively, aside from any impurities, of SiO₂, without the addition of flux.

The bar 1 advantageously results from machining a fused quartz substrate, assuming the form of a fused quartz wafer. The method consists of using a femtosecond laser to scan its variable focus over the substrate and expose the substrate to the radiation from said laser, at least along a separation area delimiting the bar 1. The separation area thus defines a latent shape of the spiral.

The exposed separation area thus has a modified morphology. In fact, the radiation of the fused quartz causes at least partial crystallization of the fused quartz. The crystalline state obtained depends on the intensity of the radiation emitted by the femtosecond laser. In any case, to “develop” the bar, the separation area thus exposed can be dissolved by wet chemical etching, typically by a bath of hydrofluoric acid or potassium hydroxide, with a selectivity of 100:1 relative to the material not exposed to the femtosecond laser. The bar 1 is thus cut out with great precision.

It is possible to provide that the bar 1 remains attached to the wafer after cutting out, by forming attachment portions. The spring is thus made easier to handle and it is possible to work in batches.

One thus obtains a bar 1 in the shape of a spiral, made from fused quartz.

As illustrated in FIG. 2b, such a bar 1 can be used, without other treatment, with a balance having a positive thermal coefficient of expansion, relatively high, in the vicinity of +15 ppm/° K. This is the case for balances for example made from brass. The physical properties of fused quartz, making up the balance spring 2, thereby make it possible to at least partially offset the thermal drift of the resonance frequency of the balance spring 2-balance 3 assembly due to the expansion of the balance.

The bar 1 resulting from cutting out the substrate can also receive different treatments intended to modulate its thermal coefficient of rigidity (TCE) and compensate for the thermal drift of its Young's modulus.

FIG. 3 illustrates an embodiment of a thermomechanical compensation of the bar 1 of FIG. 1. The bar 1 defines a core 4 at least locally covered with at least one outer layer 5 having a different structure or morphology. The outer layer 5 advantageously surrounds the entire core 4.

The outer layer 5 is for example made with a base of the material making up the core 4, i.e. fused quartz, whereof the morphology has been modified over a given thickness, through exposure to a ray coming from a femtosecond laser. The outer layer 5 is therefore made up of a thickness with a modified morphology 5a. It will be noted that, by modifying the energy of the pulses of the femtosecond laser radiation, it is possible to modulate the modification of the morphology of the exposed material. As a result, it is possible to vary the value of the thermal coefficient of rigidity of the radiated fused quartz, which can thus be substantially reduced and can even become negative with very strong radiation. The elastic behavior of the radiated fused quartz is also modified and participates in the compensation.

FIG. 4 illustrates an alternative embodiment of a thermomechanical compensation of the bar 1 of FIG. 1. In this alternative embodiment, the outer layer 5 is made with a deposition 5b of a material having a thermal coefficient of rigidity with a sign opposite that of the core 4. The deposition is done on the core 4 in non-altered fused quartz. The outer layer 5 is for example a deposition 5b of polysilicon or amorphous silicon. Such a deposition 5b is typically done by LPCVD (Low Pressure Chemical Vapor Deposition).

FIG. 5 illustrates another alternative embodiment of a thermomechanical compensation of the bar 1 of FIG. 1, combining the previous two alternatives. Thus, the outer layer 5 comprises an inner sub-layer corresponding to a thickness of modified morphology 5a of the core 4, obtained owing to the radiation of the femtosecond laser. The outer layer 5 also comprises the deposition 5b of a material having a thermal coefficient of rigidity with a sign opposite that of the core 4. Advantageously, the deposition 5b is done on the inner sub-layer 5a.

According to another embodiment of the production of the balance spring 2 according to the invention, the bar 1 has an altered morphology in its mass through radiation by a variable focus femtosecond laser. In that case, one can advantageously work at the wafer level, without “developing” the spring. One settles for forming a latent shape of the spring, as mentioned above, by forming a separation area by exposure to a femtosecond laser. Then, owing to the fact that the focal point of the femtosecond laser can be focused at any point of the bar, including discretely, the bar is radiated in its mass, but while at least locally keeping a peripheral area with a particular thickness and not exposed to the femtosecond laser, so as to allow a selective “development” of the spring and selective dissolution of the separation area. The thermal coefficient of rigidity of that peripheral area therefore remains unchanged, unlike the inner part of the bar 1. It is also possible to consider exposing the inner part of the bar to the femtosecond laser, after “development” of the spring, i.e. from a cut out spring.

The invention therefore proposes several possibilities for a fused quartz-based spring comprising thermal compensation areas. These areas can be outer or inner areas. They can consist of areas obtained by exposing the fused quartz to a femtosecond laser or, possibly for an outer area, a deposition of a different material.

The present invention also relates to a method of manufacturing the balance spring 2.

According to a first alternative, such a method consists, as mentioned above, of using a femtosecond laser to scan its variable focus on the fused quartz substrate and expose the substrate to the radiation from said laser, at least along a separation area delimiting the bar 1. The separation area thus defines a latent shape of the bar 1. The separation area thus exposed can be dissolved in a chemical bath, previously described. The spring is at least partially cut out, attachment portions to the substrate possibly remaining.

A thermal compensation treatment is then applied on the spring at least partially cut out, while forming at least one outer layer 5 with a different structure on the bar 1. The outer layer 5 can partially or completely surround the bar 1.

The compensation treatment can consist of modifying the morphology of the bar 1, over a given thickness, through exposure to radiation coming from a femtosecond laser.

The compensation treatment can also consist of depositing a layer of material having a thermal coefficient of rigidity with a sign opposite that of the material making up the bar 1. Such a deposition can be done in polysilicon or amorphous silicon, having a negative TCE. The deposition can typically be done by LPCVD (Low Pressure Chemical Vapor Deposition). Such a deposition can be done directly on the bar 1. It is also possible to perform such a deposition on an outer layer with a morphology altered through exposure to a femtosecond laser.

The sub-layers thus make it possible to modify the thermal coefficient of rigidity of the assembly. If the exposure to the femtosecond laser was too great and, as a result, the compensation is excessive, it is possible to remove part of the exposed layer to decrease the compensation, typically through chemical action.

According to a second alternative, the method consists of delimiting, with the separation area, a latent shape of the spiral bar 1 and exposing the core 4 of the latent shape to the femtosecond laser before the dissolution of said separation area, while keeping a non-exposed enclosure 6 of said core 4. The method then consists of freeing the latent shape via the dissolution of the separation area in a chemical bath. One example of the bar 1 thus obtained is illustrated in section in FIG. 6. The core 4 thus has the unaltered enclosure 6 in its morphology.

The invention thus offers the possibility of preforming a large number of balance springs in a plate or in a substrate of fused quartz and performing, in a localized manner, a femtosecond laser treatment causing a mechanical-thermal compensation. It is possible to work in batches, at the wafer level, by not separating the balance springs from the plate. The handling and positioning of such a plate for treatment or cutting out purposes are much easier than individual handling and positioning of each balance spring.

Depending on the targeted application, one skilled in the art may determine the thermal coefficient of elasticity he wishes to obtain, either to produce a spring having as low a thermal drift as possible, or to produce a spring having a thermal drift compensating that of the balance with which it is associated. One skilled in the art may determine, through calculation and modeling, the locations and thicknesses of the thermal compensation areas. The thermomecanical compensation possibilities are then extremely diverse and numerous in the context of the present invention.

Another advantage of the invention lies in the fact that it makes it possible to obtain a thermally compensated balance spring-balance assembly, using a spring made only from fused quartz not radiated by the femtosecond laser.

Furthermore, it will be noted that the balance spring obtained according to the invention is transparent. It thus participates in the esthetics of the movement in which it is placed.

The present description is of course not limited to the examples explicitly described, but also comprises other embodiments and/or implementations. Thus, a described technical feature or step can be replaced by an equivalent technical feature or step, respectively, without going beyond the scope of the present invention.

1. A balance spring intended to equip a balance of a mechanical timepiece, formed by a spiral bar formed by a fused quartz core at least locally covered with at least one outer layer having a different structure to modify the thermal coefficient of rigidity.

2. The balance spring of claim 1, wherein the outer layer is made a deposition of a material having a thermal coefficient of rigidity with a sign opposite that of the core.

3. The balance spring of claim 1, wherein the outer layer is made with the fused quartz of the core, the morphology of which has been modified by exposure to a femtosecond laser.

4. The balance spring of claim 1, wherein the outer layer comprises an outer sub-layer made with a deposition of a material having a thermal coefficient of rigidity with a sign opposite that of the core and an inner sub-layer made with the fused quartz of the core, the morphology of which has been modified by exposure to a femtosecond laser.

5. The balance spring of claim 3, wherein the fused quartz whereof the morphology has been modified, has an at least partially crystallized structure.

6. A balance spring-balance assembly, said balance having a positive thermal coefficient of expansion, said assembly having a thermal drift compensation of the resonance frequency, wherein the material making up the balance spring is fused quartz whereof the thermal coefficient of rigidity is positive, arranged so as to compensate for the thermal drift of the resonance frequency due to the expansion of the balance.

7. A method of manufacturing a balance spring, comprising the following steps:
cutting out a spiral bar in a fused quartz substrate,
using a femtosecond laser to scan its variable focus on the substrate and expose the substrate to said laser at least along a separation area thereby delimiting the spiral bar, the exposed separation area thus having a modified morphology, and
dissolving at least part of said separation area in a selective chemical bath.

8. The method of claim 7, comprising moreover the step of applying a thermal compensation treatment on said bar at least partially cut out, by covering the bar with at least one outer layer having a different structure.

9. The method of claim 8, wherein said thermal compensation treatment consists of modifying the morphology of the bar, over a given thickness, through exposure to radiation coming from a femtosecond laser.

10. The method according to claim 8, wherein said thermal compensation treatment consists of depositing a layer of a material having a thermal coefficient of rigidity with a sign opposite that of the material making up the bar.

11. The method of claim 7, comprising the following steps:
delimiting a latent shape of the spiral bar with the separation area,
exposing, before dissolution of the separation area, a core of the latent shape using the femtosecond laser while keeping an unexposed enclosure of said core, and
freeing the latent shape through dissolution of the separation area.

12. The balance spring of claim 4, wherein the fused quartz whereof the morphology has been modified, has an at least partially crystallized structure.
